(19) United States
(12) Patent Application Publication
(10) Pub. No.: US 2005/0238779 A1
(43) Pub. Date: Oct. 27, 2005

(54) Low-calorie beverages and sweetener composition with improved palatability

(75) Inventors: Naoko Isoya, Kawasaki-shi (JP); Keiko Sato, Kawasaki-shi (JP); Yasuyuki Tomiyama, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 11/114,019

(22) Filed: Apr. 26, 2005

(30) Foreign Application Priority Data
Apr. 26, 2004 (JP) 2004-129274

(51) Int. Cl. A23L 1/236

(52) U.S. Cl. 426/548; 426/590

(57) ABSTRACT

The invention described herein provide beverages which have excellent palatability and are limited in calorie content and a sweetener composition having the same characteristics, which contain sucralose and acesulfame K.

### BACKGROUND OF THE INVENTION

1. Field of the Invention

The present invention relates to low-calorie beverages and a sweetener composition with improved palatability, which contains the highly-intensive sweeteners acesulfame K (Ace-K) and sucralose are contained. The beverages and composition may also contain aspartame (APM), saccharides or/and sugar alcohol at a specified ratio. The sweetener composition containing such sweeteners is highly effective in providing products which possess a highly-desired natural sweetness.

2. Description of the Background Art

Sweeteners having high sweetness, such as APM, Ace-K and sucralose have been widely used in dietary foods (including beverages) as sweeteners because of their intensive sweetness. In particular, with respect to beverages that are consumed in huge quantities, they have been used in low-calorie beverages such as reduced-calorie or non-calorie beverages and in various sugarless beverages, in particular cola beverages.

However, consumers have long been accustomed to tastes of the products (hereinafter referred to as regular products) made from sugar or high fructose corn syrup (hereinafter abbreviated as HFCS). As a result, consumers may perceive that the taste of products made using the highly-intensive sweeteners to be strange or unpleasant.

APM has useful effects to enhance flavor and decrease bitter or acrid taste ascribable to other component materials of beverage products. However, its strong sweet aftertaste and storage stability is problematic.

While sucralose has high stability, there are problems with this sweetner, i.e., it suppresses flavor and its sweet aftertaste is heavy.

Ace-K has the characteristics of high stability and a synergistic effect with APM which increases the sweetness intensity and improves the mutual tastes thereof. However, because of its strong bitter or acrid taste, Ace-K cannot readily be used as a single sweetener.

Regarding these three high intensive sweeteners, various studies have been made, and examples thereof include the combined use with trehalose, erythritol or the like (JP-A-2002-51723), the combined use with dietary fiber (JP-A-2004-41118), the combined use with a-glucosylated stevia extract (JP-A-2002-34501) and the like. However, these compositions have not satisfied the palatability of consumers who have long been accustomed to the taste of sugar or HFCS.

Meanwhile, especially in developed countries such as the U.S., obesity is an increasingly serious problem, and it has been recommended to limit the use of saccharides such as sugar and HFCS, fats, oils, and the like. However, in the U.S., the consumption quantities of carbonated beverages has increased considerably over the years.

In view of the foregoing, foods which are controlled in calorie content and which have excellent in palatability have been desired in the field of carbonated beverages in particular.

### SUMMARY OF THE INVENTION

It is an object of the invention to provide foods, especially carbonated beverages, which are excellent in palatability and limited in calories. It is another object to provide a sweetener composition having the same characteristics.

The present inventors have assiduously conducted investigations to achieve the objects described above, and they have unexpectedly found that foods which are closer in taste to regular products made from sugar or HFCS, excellent in palatability and controlled in calorie content can be provided by using the three high intensive sweeteners described above at an appropriate ratio in combination with saccharides such as sugar and HFCS. For example, it has been found that when APM and Ace-K are jointly used in the combination of sugar and HFCS with sucralose, the taste can be made closer to that of regular products using sugar and HFCS alone while making the calorie content lower than that of the regular products. The present inventors have further continued the investigations, during which they have found that when high intensive sweeteners are used at an appropriate ratio, foods having excellent palatability and controlled calorie can be provided without the combined use of saccharides.

Thus, the present invention relates to low-calorie beverages excellent in palatability which are sweetened by high intensive sweeteners of Ace-K, sucralose and APM, or saccharides or/and sugar alcohol in addition thereto, at a fixed weight ratio. Moreover, the present invention relates to a sweetener composition having the same characteristics, in which Ace-K, sucralose and APM and, saccharides or/and sugar alcohol in addition thereto, are contained as active ingredients at the foregoing fixed weight ratio.

In particular, the present invention provides a low-calorie beverage with improved palatability, comprising sucralose and acesulfame K as sweeteners, where the sucralose:acesulfame K weight ratio is from 1:0.5 to 1:4.

The present invention also provides a low-calorie sweetener composition with improved palatability, comprising sucralose and acesulfame K as sweeteners, where the sucralose:acesulfame K weight ratio is from 1:0.5 to 1:4.

The invention provides foods, especially carbonated beverages, which are excellent in palatability and limited in calorie, and a sweetener composition having the same characteristics.

### BRIEF DESCRIPTION OF THE DRAWING

FIG. 1 shows the results of sensory evaluation of three types of cola shown in Table 1.

### DETAILED DESCRIPTION OF THE PREFERRED EMBODIMENTS

The beverages whose calorie content is reduced by the method of the present invention are carbonated beverages such as cola, isotonic drinks, fruit juice beverages, milk beverages, tea beverages and the like. As discussed above, carbonated beverages which give rise to a problem of obesity by drinking in large quantities are an important embodiment of the present invention.

The low-calorie beverages of the present invention can properly be prepared by a conventional method except for the use of the aforementioned high intensive sweeteners, or saccharides or/and sugar alcohol in addition thereto, being added at a fixed ratio. Such methods are widely known in the art.

The fixed ratio here referred to is; when sweetened with sucralose and Ace-K, the weight ratio of the former to the latter is in the range of from 1:0.5 to 1:4. That range includes all values and subranges therebetween, such as 1:0.75, 1:1, 1:1.5, 1:2, 1:2.5, 1:3 and 1:3.5. A weight ratio outside this range is undesirable in view of palatability.

It is also possible for the beverage to be sweetened with APM in addition to sucralose and Ace-K. In this case, the A:B ratio of the weight (A) of APM to the total weight (B) of sucralose and Ace-K having the foregoing weight ratio is in the range of from 0.1:1 to 10:1, preferably from 1:1 to 5:1, more preferably from 1:1 to 3.5:1. Those ranges include all values and subranges therebetween, such as 0.25:1, 0.5:1, 0.75:1, 1.5:1, 2:1, 3:1, 4:1, 6:1, 7:1, 8:1 and 9:1. The weight ratio outside these ranges is undesirable in view of palatability.

In addition to the foregoing high intensive sweeteners, saccharides such as sugar, HFCS, fructose and glucose or/and sugar alcohols such as erythritol, maltitol and xylitol may be used in combination. In this case, the fixed ratio is, in case of beverages, from 1 to 10% by weight of the total beverages, and it is, in case of the sweetener composition, from 0.5 to 15% by weight of the total sweetener composition. These ranges include all values and subranges therebetween, such as 0.75, 1.5, 2, 3, 5, 6, 7, 8 and 9% by weight.

The present invention also provides a sweetener composition. Active ingredients of sweetness in the sweetener composition are sucralose and Ace-K, or APM in addition thereto, or all of these sweeteners and saccharides or/and sugar alcohol, as described above as components of the low-calorie beverages.

Such a sweetener composition may contain an appropriate excipient which does not impair the object of the present invention in foods to be sweetened in view of convenience to use the high intensive sweeteners as active ingredients, for example, an excipient such as dietary fiber for cola beverages. A composition (mixture) comprising only the aforementioned high intensive sweeteners or comprising these sweeteners and saccharides or/and sugar alcohol without addition of such an excipient is also within the scope of the sweetener composition of the invention.

When foods are reduced in calorie according to the invention, the aforementioned high intensive sweeteners or the sweeteners and saccharides or/and sugar alcohol are once formed into the sweetener composition of the invention, and foods can be sweetened using this composition. However, it goes without saying that the high intensive sweeteners, or the sweeteners and saccharides or/and sugar alcohol may directly be added to foods to be sweetened at a fixed ratio without formation of such a sweetener composition.

### EXAMPLES

The invention is illustrated in more detail below by reference to the Example. However, the scope of the invention is not limited by the Example.

### Example 1

### Half-Calorie Cola

A cola was prepared according to a formulation of Table 1 below. As a result of evaluation by sweetener specialists (N=8), it was confirmed that the invention product (Sample 1) was closer in palatability to Control as a regular product than a product (Sample 2) using a combination of HFCS, sugar and sucralose as a comparative product.

TABLE 1
Formulation

| | Control | Sample 1 | Sample 2 |
|---|---|---|---|
| Granules | 5.85 | 2.93 | 2.93 |
| HFCS | 3.9 | 1.95 | 1.95 |
| APM | — | 0.0094 | — |
| Ace-K | — | 0.0014 | — |
| Sucralose | — | 0.0022 | 0.0087 |
| Cola base | 0.2 | 0.2 | 0.2 |
| Citric acid (crystal) | 0.025 | 0.025 | 0.025 |
| Sodium citrate | 0.01 | 0.01 | 0.01 |
| Phosphoric acid | 0.03 | 0.03 | 0.03 |
| (85%) | | | |
| Cola flavor M-80051 | 0.1 | 0.1 | 0.1 |
| Deionized water | balance | balance | balance |
| Total | 100% | 100% | 100% |

(% by weight)

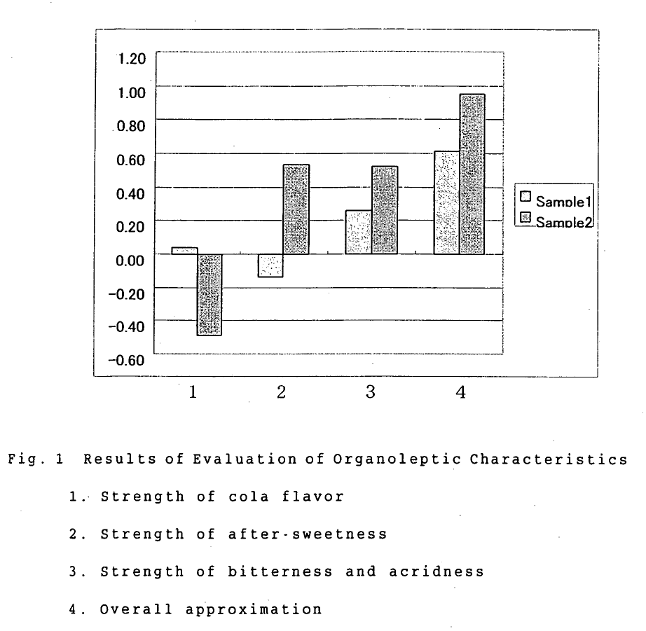

The evaluation was performed by a paired method using Scheffe's paired comparison. The results are shown in FIG. 1. As is understandable the FIGURE, with respect to strength of sweet aftertaste, Sample 2 is stronger than the Control, while the invention product is much closer to the Control. With respect to strength of bitterness and acridness, Sample 2 is also stronger than the Control, while the invention product is much closer to the Control. With respect to strength of the cola flavor, Sample 2 is much lower than the Control, while the invention product is equal to the Control.

In FIG. 1, the value in the ordinate is determined as follows. That is, relative to the Control, each evaluation item is evaluated by 7 grades, −3 (very weak)/−2 (weak)/−1 (slightly weak)/0 (equal)/1 (slightly strong)/2 (strong)/3 (very strong), and an average value of scores of each panelist is shown. Only “Overall approximation” is shown in terms of an average value of scores using 0 (equal)/1 (slightly different)/2 (different)/3 (quite different).

The present application is based on Japanese Patent Application No. 129274/2004, filed on Apr. 26, 2004, and incorporated herein by reference.

1. A low-calorie beverage with improved palatability, comprising sucralose and acesulfame K as sweeteners, wherein the sucralose:acesulfame K weight ratio is from 1:0.5 to 1:4.

2. The low-calorie beverage of claim 1, further comprising aspartame as a sweetener, wherein the weight ratio of the aspartame (A) to the total amount of sucralose and acesulfame K (B) (A:B) is from 0.1:1 to 10:1.

3. The low-calorie beverage of claim 2, wherein the weight ratio A:B is from 1:1 to 5:1.

4. The low-calorie beverage of claim 2, wherein the weight ratio A:B is from 1:1 to 3.5:1.

5. The low-calorie beverage of claim 1, further comprising saccharides or/and sugar alcohol in an amount of from 1 to 10% by weight of the beverage.

6. The low-calorie beverages of claim 1, which is a carbonated beverage.

7. The low-calorie beverages of claim 1, which is a cola, isotonic drink, fruit juice beverage, milk beverage or a tea beverage.

8. A low-calorie sweetener composition with improved palatability, comprising sucralose and acesulfame K as sweeteners, wherein the sucralose:acesulfame K weight ratio is from 1:0.5 to 1:4.

9. The low-calorie sweetener composition of claim 8, further comprising aspartame as a sweetener, wherein the weight ratio of the aspartame (A) to the total amount of sucralose and acesulfame K (B) (A:B) is from 0.1:1 to 10:1.

10. The low-calorie sweetener composition of claim 9, wherein the weight ratio A:B is from 1:1 to 5:1.

11. The low-calorie sweetener composition of claim 9, wherein the weight ratio A:B is from 1:1 to 3.5:1.

12. The low-calorie sweetener composition of claim 8, further comprising saccharides or/and sugar alcohol in an amount of from 0.5 to 15% by weight.

13. A method of preparing the beverage of claim 1, comprising combining the sucralose and acesulfame K.

14. A method of preparing the sweetener composition of claim 8, comprising combining the sucralose and acesulfame K.
